(19) United States
(12) Patent Application Publication
(10) Pub. No.: US 2016/0162765 A1
(43) Pub. Date: Jun. 9, 2016

(54) IMAGE FORMING APPARATUS, IMAGE FORMING SYSTEM AND IMAGE FORMING METHOD

(71) Applicant: KONICA MINOLTA, INC., Tokyo (JP)

(72) Inventor: Shigeo KONUMA, Tokyo (JP)

(73) Assignee: KONICA MINOLTA, INC., Tokyo (JP)

(21) Appl. No.: 14/958,554

(22) Filed: Dec. 3, 2015

(30) Foreign Application Priority Data
Dec. 5, 2014 (JP) 2014-246392

(51) Int. Cl. G06K 15/00; H04N 1/00; B65H 1/26

(52) U.S. Cl. CPC G06K 15/4065; B65H 1/266; H04N 1/00411; H04N 1/00623; H04N 1/00724; H04N 1/00771; H04N 1/0032; B65H 2220/01

(57) ABSTRACT

An image forming apparatus, image forming system and image forming method are shown. The image forming apparatus includes a sheet feeding tray, an image forming unit, and a control unit. The sheet feeding tray stores and feeds a sheet. The image forming unit forms an image on a sheet fed from the sheet feeding tray. The control unit controls the image forming unit to form an image including information regarding a sheet before changing when operation including changing of a sheet stored in the sheet feeding tray is performed or there is a necessity to change a sheet stored in the sheet feeding tray.

### BACKGROUND

1. Field of the Invention

The present invention relates to an image forming apparatus, an image forming system and an image forming method.

2. Description of Related Art

Conventionally, in image forming apparatuses such as copying machines, printers and the like, image forming is performed based on various setting information such as image forming condition, operation setting, etc. In order to confirm such setting information, a function to display the setting information and to print the setting information is provided in the image forming apparatus. For example, there is a printer in which, when there is a print instruction of the printer setting information, text data representing the printer setting information is created, the rasterizing processing is performed on the text data to generate the print image, and the printer setting information is printed based on the generated print image (See Japanese Patent Application Laid-Open Publication No, 2005-246820).

The information regarding the sheet is included in the setting information in the image forming apparatus. In the image forming apparatus, setting information regarding the sheet such as, the type of sheet, the basis weight, the adjustment value matching the sheet feeding tray, etc. is registered as the sheet profile. Image forming is performed using the sheet profile most suitable for each sheet.

When the sheet of the sheet feeding tray in the image forming apparatus is changed, the sheet originally loaded in the sheet feeding tray is taken out. In order to use this sheet in the future again, the sheet taken out and the information of the sheet need to be associated with each other. For example, the sheet taken out needs to be returned to storage in which the information of the sheet is managed.

However, the sheet taken out from the sheet feeding tray may be temporarily left around the image forming apparatus. In this case, it becomes unclear what type of sheet the sheet is, and there is a possibility that a suitable sheet profile may not be set when the sheet is used next time. For example, even if the sheet size is the same, if the type of sheet, basis weight, etc., are different, the sheet profile to be used is also different. However, sheets which are open from the package are not associated with information such as the attribute of the sheet, the sheet profile, etc., and there is a problem that the image cannot be formed suitably for the sheet.

### SUMMARY

The present invention has been made in consideration of the above problems, and one of the main objects is to easily manage information regarding a sheet which is taken out when a sheet in a sheet feeding tray is changed.

In order to achieve at least one of the above-described objects, according to an aspect of the present invention, there is provided an image forming apparatus including:

a sheet feeding tray which stores and feeds a sheet;

an image forming unit which forms an image on a sheet fed from the sheet feeding tray; and

a control unit which controls the image forming unit to form an image including information regarding a sheet before changing when operation including changing of a sheet stored in the sheet feeding tray is performed or there is a necessity to change a sheet stored in the sheet feeding tray.

Preferably, in the image forming apparatus, the operation including changing of the sheet includes changing information regarding the sheet stored in the sheet feeding tray or opening or closing of the sheet feeding tray.

Preferably, in the image forming apparatus, the control unit displays on a display unit a confirmation screen to select whether to change the sheet or to supply the sheet when the sheet feeding tray is opened, and when the change of the sheet is selected, the control unit controls the image forming unit to form the image including the information regarding the sheet before changing when the sheet feeding tray is closed.

Preferably, in the image forming apparatus, the control unit determines that the sheet needs to be changed when a sheet specified in a job is different from a sheet stored in the sheet feeding tray.

Preferably, in the image forming apparatus, the control unit displays on a display unit a confirmation screen to select whether to form an image including information regarding the sheet before changing, and when forming the image including the information regarding the sheet before changing is selected, the control unit controls the image forming unit to form an image including the information regarding the sheet before changing.

Preferably, in the image forming apparatus, the information regarding the sheet before changing includes at least one of the following, information showing a sheet profile of the sheet before changing, an attribute of the sheet before changing or control information of the sheet before changing.

Preferably, the image forming apparatus further includes, an image reading unit which reads information regarding the sheet before changing from a sheet on which an image including information regarding the sheet before changing is formed,

wherein, the control unit sets a sheet profile corresponding to information regarding the sheet before changing based on the information regarding the sheet before changing read by the image reading unit as information of a sheet newly stored in the sheet feeding tray.

Preferably, in the image forming apparatus,

the sheet on which the image including the information regarding the sheet before changing is formed is stored as the first sheet to be fed with the sheet before changing in the sheet feeding tray; and

the image reading unit reads the information regarding the sheet before changing from the first sheet fed from the sheet feeding tray.

Preferably, in the image forming apparatus, the control unit notifies that the sheet profile is not automatically set when the image reading unit cannot read information regarding the sheet before changing or there is no sheet profile corresponding to the information regarding the sheet before changing read by the image reading unit.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a schematic diagram showing a configuration of an image forming apparatus regarding an embodiment of the present invention;

FIG. 2 is a block diagram showing a functional configuration of the image forming apparatus;

FIG. 3 is a flowchart showing a sheet setting changing process based on user operation;

FIG. 4 is a diagram showing a sheet setting screen;

FIG. 5 is a flowchart showing sheet profile printing process A;

FIG. 6 is a diagram showing a confirmation screen of sheet profile printing;

FIG. 7 is a diagram showing a print mode screen;

FIG. 8 is an example of a sheet on which the sheet profile is printed;

FIG. 9 is a diagram showing a setting changing screen;

FIG. 10 is a flowchart showing sheet setting changing process based on operation of opening/closing the sheet feeding tray;

FIG. 11 is a flowchart showing a sheet profile printing process B;

FIG. 12 is a flowchart showing a sheet setting changing process based on sheet incompatibility;

FIG. 13 is a flowchart showing a sheet profile setting process; and

FIG. 14 is a diagram showing a confirmation screen for automatic reading of sheet profile.

### DETAILED DESCRIPTION OF PREFERRED EMBODIMENTS

An embodiment of the image forming apparatus according to the present invention is described below. The present invention is not limited to the illustrated examples.

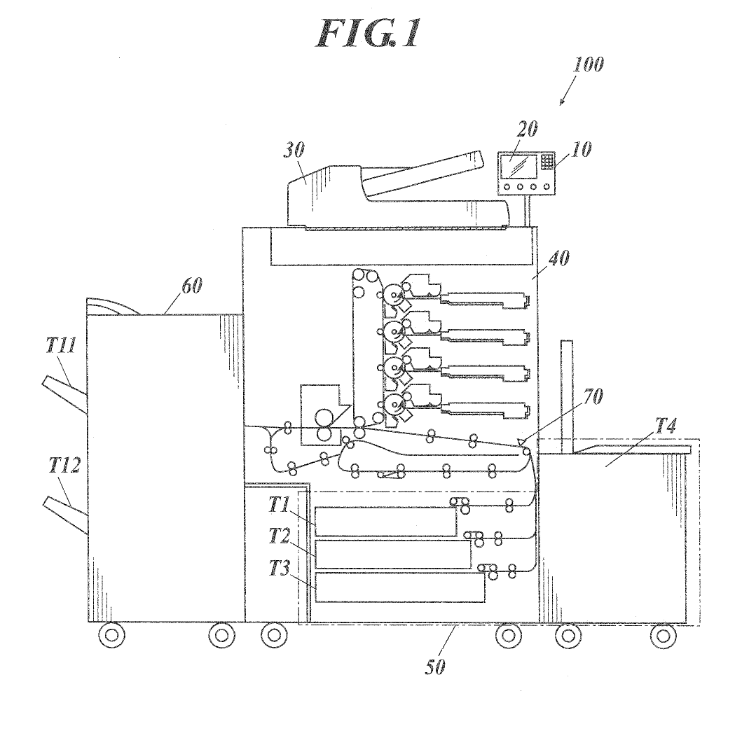

FIG. 1 is a schematic diagram of a configuration of an image forming apparatus 100.

The image forming apparatus 100 includes an operation unit 10, a display unit 20, a scanner unit 30, an image forming unit 40, a sheet feeding unit 50, a sheet processing unit 60, an image reading unit 70, and the like.

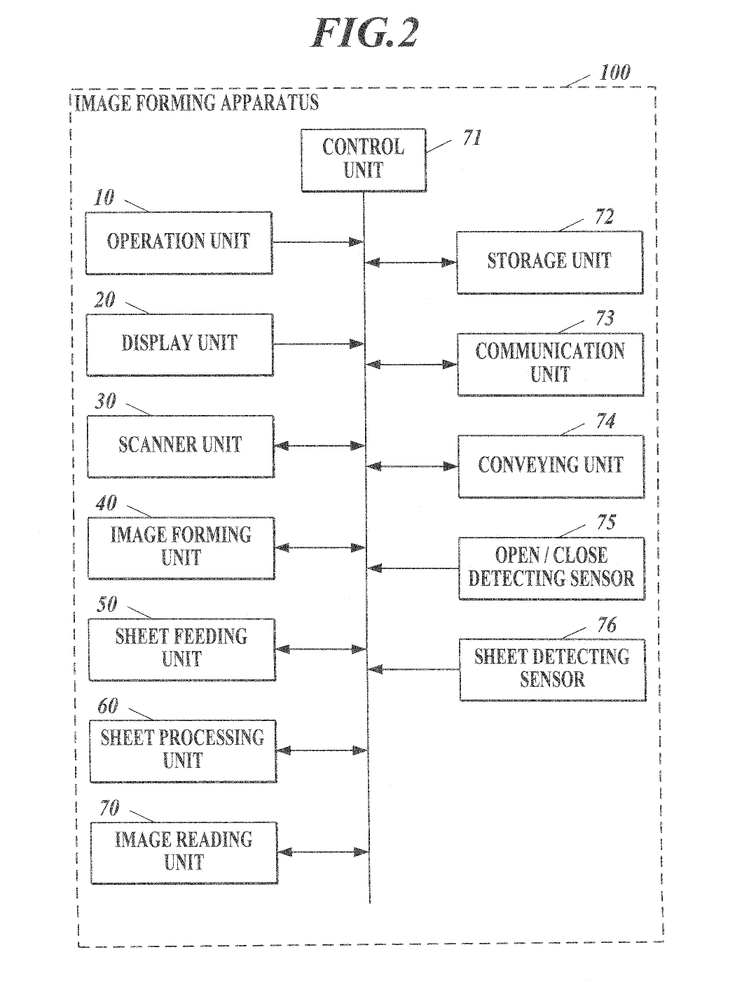

The operation unit 10 includes a touch panel formed so as to cover a display screen of the display unit 20 and various operation buttons such as numeric buttons, and a start button. The operation unit 10 outputs an operation signal based on operation of the user to the control unit 71 (see FIG. 2).

The display unit 20 includes a LCD (Liquid Crystal Display), a EL (Electro Luminescence), etc., and displays various screens according to an instruction of a display signal input from a control unit 71.

The scanner 30 includes an ADF (automatic document feeder). The scanner 30 reads the image of the document to output the obtained image data to the control unit 71.

The image forming unit 40 forms an image on a sheet supplied from sheet feeding trays T1 to T4 of the sheet feeding unit 50 based on image data read from the scanner unit 30 or the image data received from the external apparatus.

The sheet feeding unit 50 includes a plurality of sheet feeding trays T1 to T4 and supplies sheets to the image forming unit 40. The sheet feeding trays T1 to T4 store sheets with a type and size determined in advance in each sheet feeding tray.

The sheet processing unit 60 performs sheet processing such as sorting, stapling, hole punching, folding, binding as necessary on a sheet with an image formed by the image forming unit 40. The sheet processing unit 60 ejects the sheet from a sheet ejecting tray T11 or sheet ejecting tray T12.

The image reading unit 70 includes a line sensor in which a plurality of light receiving elements are positioned with a predetermined interval in a direction orthogonal to the sheet conveying direction. The image reading unit 70 reads the image on the sheet supplied from the sheet feeding trays T1 to T4 and outputs the obtained image data to the control unit 71. The light receiving elements output a signal according to the intensity of the light emitted from the light source reflecting on the surface of the sheet. For example, a CCD (Charge Coupled Device) sensor or a CMOS (Complementary Metal Oxide Semiconductor) sensor is used as the line sensor.

FIG. 2 is a block diagram showing a functional configuration of the image forming apparatus 100.

As shown in FIG. 2, the image forming apparatus 100 includes an operation unit 10, a display unit 20, a scanner unit 30, an image forming unit 40, a sheet feeding unit 50, a sheet processing unit 60, an image reading unit 70, a control unit 71, a storage unit 72, a communication unit 73, a conveying unit 74, an open/close detecting sensor 75, a sheet detecting sensor 76, and the like. The description of the functional units already described is omitted.

The control unit 71 includes a CPU (Central Processing Unit), a ROM (Read Only Memory), a RAM (Random Access Memory) and the like. According to an operation signal input from the operation unit 10 or an instruction signal received by the communication unit 73, the CPU reads out various processing programs stored in the ROM to be developed in the RAM and the operation of each unit in the image forming apparatus 100 is centrally controlled according to the developed program.

The storage unit 72 includes a hard disk, flash memory or the like, and various types of data are stored. The sheet profile is associated with each of the plurality of sheet profile numbers and stored in the storage unit 72. The sheet profile is information showing how the sheet is treated in the image forming apparatus 100 and includes the sheet attribute, the sheet control information, and the like. The sheet size, sheet type, basis weight, color, etc. are included in the sheet attribute. The sheet control information includes front/back adjustment value such as magnitude and shift amount of front face and back face in double sided printing, process adjustment value such as secondary transfer output, fixing temperature, and fixing speed, and the like. The sheet profile used for the sheet stored in each sheet feeding tray is associated with each sheet feeding tray T1 to T4 and stored in the storage unit 72.

The communication unit 73 transmits and receives data between external apparatuses connected to the communication network such as a LAN (Local Area Network), etc.

The conveying unit 74 includes a conveying roller to convey the sheet and conveys the sheet in the image forming apparatus 100.

The open/close detecting sensor 75 is provided in each sheet feeding tray T1 to T4 of the sheet feeding unit 50. The open/close detecting sensor 75 detects whether the sheet feeding trays T1 to T4 are open (pulled out) or closed (returned from being pulled out) and outputs the detected result to the control unit 71.

The sheet detecting sensor 76 is provided in each sheet feeding tray T1 to T4 of the sheet feeding unit 50. The sheet detecting sensor 76 detects whether there are any sheets in the sheet feeding trays T1 to T4 and outputs the detected result to the control unit 71.

The control unit 71 controls the image forming unit 40 to form an image including information regarding sheets before changing when there is operation including changing of sheets stored in the sheet feeding trays T1 to T4 or the sheets stored in the sheet feeding trays T1 to T4 need to be changed.

“Operation including changing of sheets” is operation of changing information regarding the sheets stored in the sheet feeding trays T1 to T4 or operation of opening and closing the sheet feeding trays T1 to T4.

“Information regarding sheets before changing” includes at least one of the following, information showing sheet profile of the sheet before changing, the attribute of the sheet before changing or the control information of the sheet before changing. As information showing sheet profile, there are sheet profile number, sheet profile name, etc. “Information regarding sheets before changing” is not limited to forming an image as text information, and can be represented by a barcode, a two-dimensional code or the like.

When the sheet feeding trays T1 to T4 are opened, the control unit 71 displays on the display unit 20 a confirmation screen to select whether to change the sheets or to supply sheets. When it is selected on the confirmation screen to change the sheets, the control unit 71 controls the image forming unit 40 to form the image including the information regarding the sheets before changing at the timing that the sheet feeding trays T1 to T4 are closed.

The control unit 71 compares the sheet specified in the job with the sheet stored in the sheet feeding trays T1 to T4. The control unit 71 determines that the sheets need to be changed when the sheet specified in the job is different from the sheet stored in the sheet feeding trays T1 to T4.

The control unit 71 displays on the display unit 20 a confirmation screen to select whether to form an image including information regarding the sheet before changing. The control unit 71 controls the image forming unit 40 to form the image including the information regarding the sheet before changing when a selection is made to form the image including information regarding the sheet before changing.

The user takes out a bundle of sheets which is a target of changing from the sheet feeding trays T1 to T4 and stores the sheet on which the image including the information regarding the sheet before changing is formed placed on top of the bundle of sheets.

When the bundle of sheets temporarily taken out and stored is set in the sheet feeding trays T1 to T4, the user stores the sheet on which the image including the information regarding the sheet before changing is formed as the first fed sheet with the sheets before changing (sheets which are taken out and stored temporarily) in the sheet feeding trays T1 to T4.

The control unit 71 controls the image reading unit 70 to read the information regarding the sheet before changing from the sheet on which the image including the information regarding the sheets before changing is formed. Specifically, the control unit 71 controls the sheet feeding unit 50 to supply one sheet from the sheet feeding trays T1 to T4 with newly stored sheets and controls the conveying unit 74 to convey the first sheet fed from the sheet feeding trays T1 to T4 to the image reading unit 70. Then, the control unit 71 controls the image reading unit 70 to read the information regarding the sheet before changing from the first sheet fed from the sheet feeding trays T1 to T4 with newly stored sheets.

Based on the information regarding the sheet before changing read by the image reading unit 70, the control unit 71 sets the sheet profile corresponding to the information regarding the sheet before changing as the information of the sheet newly stored in the sheet feeding trays T1 to T4.

The control unit 71 notifies the automatic setting of the sheet profile is not performed when the information regarding the sheet before changing is not read by the image reading unit 70 or there is no sheet profile corresponding to the information regarding the sheet before changing read by the image reading unit 70.

Next, the operation in the image forming apparatus 100 is described.

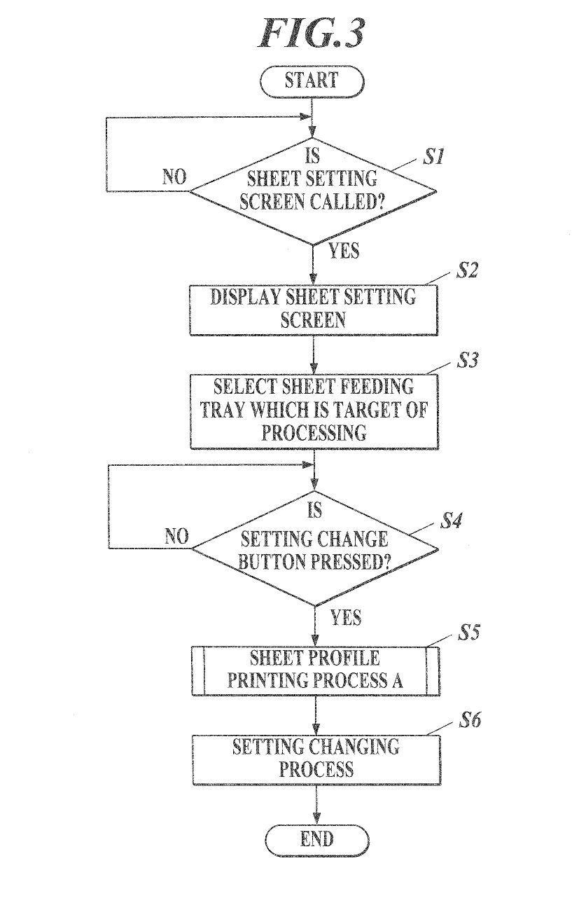

FIG. 3 is a flowchart showing a sheet setting changing process based on user operation performed by the image forming apparatus 100. The process is realized by software processing performed by the CPU of the control unit 71 in coordination with a program stored in the ROM.

The control unit 71 judges whether the user operated the operation unit 10 to call the sheet setting screen (step S1). For example, when the user presses the sheet setting button displayed on the display unit 20, the sheet setting screen is called.

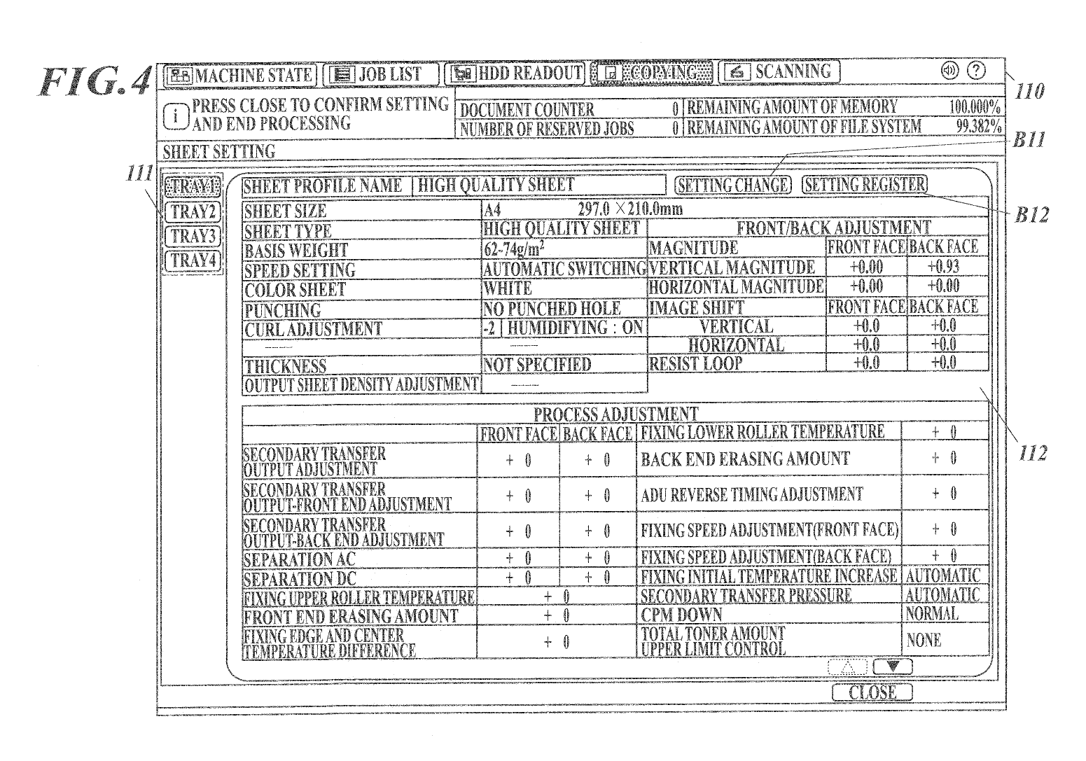

When the sheet setting screen is called (step S1; YES), the control unit 71 displays the sheet setting screen 110 (see FIG. 4) on the display unit 20 (step S2).

FIG. 4 shows an example of a sheet setting screen 110 displayed on the display unit 20. The sheet setting screen 110 includes a tray selecting region 111, a sheet setting display region 112, a setting change button B11, a setting register button B12 and the like. A tray selecting region 111 is a region to select a sheet feeding tray as the target of processing from the sheet feeding trays T1 to T4. The sheet setting display region 112 is a region where the setting of the sheet (setting content information regarding the sheet) for the sheet feeding tray selected in the tray selecting region 111 is displayed. The control unit 71 reads the sheet profile corresponding to the selected sheet feeding tray from the storage unit 72 and displays on the sheet setting display region 112 the sheet setting for the selected sheet feeding tray based on the sheet profile. The setting change button B11 is a button to instruct change of the sheet setting for the sheet feeding tray selected in the tray selecting region 111. The setting register button B12 is a button to instruct the registration of the sheet setting for the sheet feeding tray selected in the tray selecting region 111.

Next, when the user operates the operation unit 10 to select the sheet feeding tray as the target of processing in the tray selecting region 111 of the sheet setting screen 110, the control unit 71 sets the selected sheet feeding tray as the processing target (step S3).

Next, the control unit 71 judges whether the user operated the operation unit 10 and pressed the setting change button B11 of the sheet setting screen 110 (step S4). When the setting change button B11 is pressed (step S4; YES), in other words, when the operation is performed to change the information regarding the sheet stored in the selected sheet feeding tray, the control unit 71 performs sheet profile printing process A (step S5).

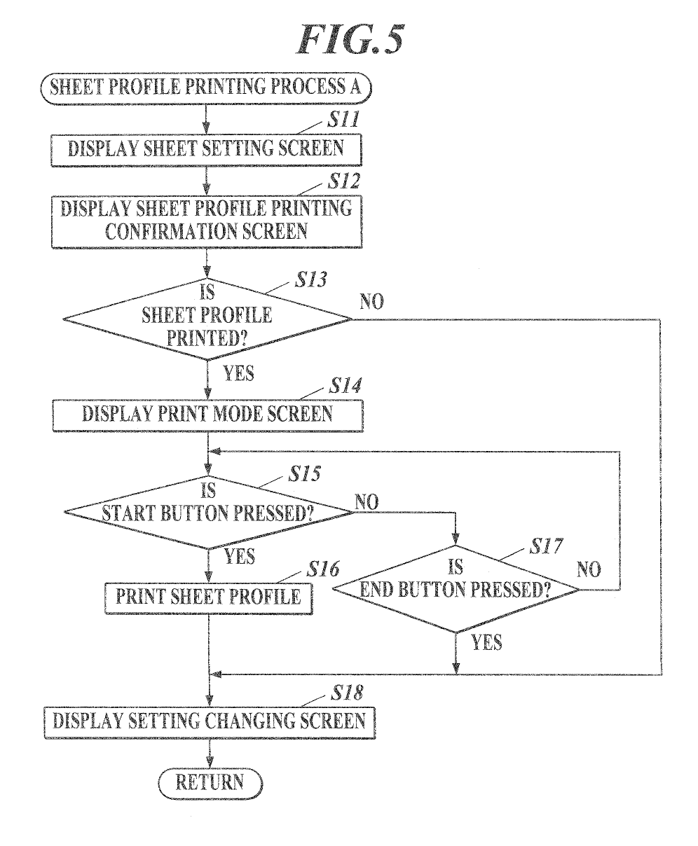

FIG. 5 shows sheet profile printing process A.

The control unit 71 displays the sheet setting screen 110 (see FIG. 4) on the display unit 20 (step S11).

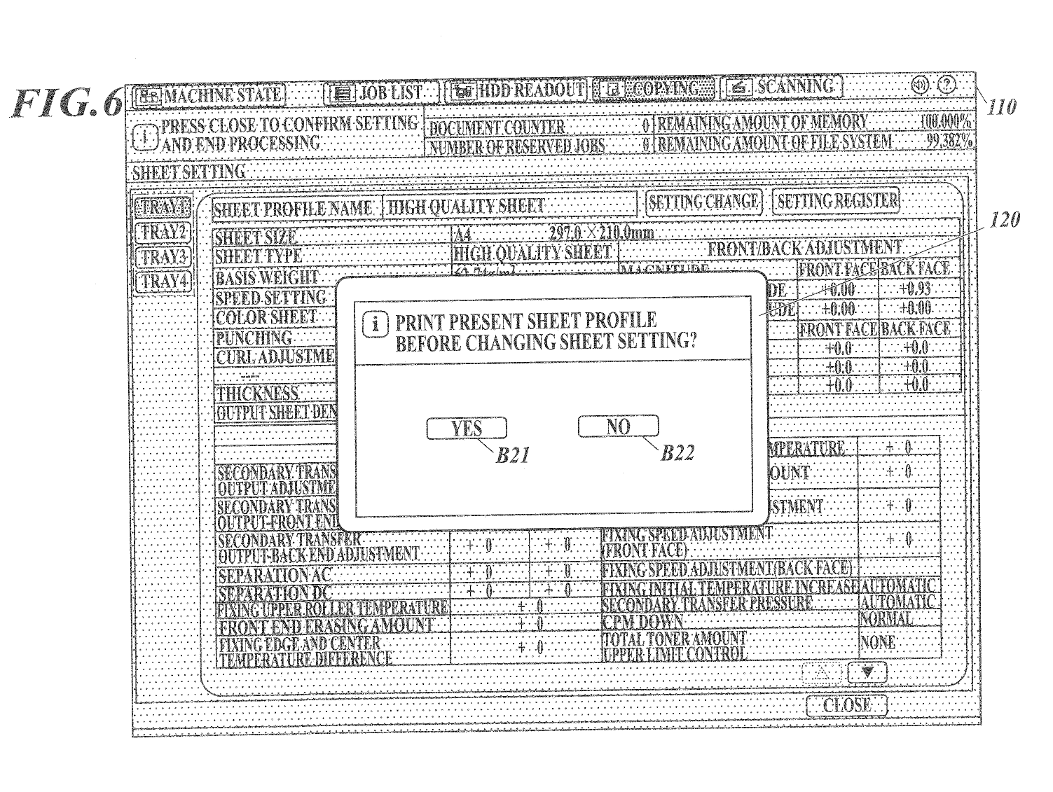

Next, the control unit 71 displays a sheet profile printing confirmation screen 120 (see FIG. 6) on the sheet setting screen 110 of the display unit 20 (step S12).

FIG. 6 shows an example of the sheet profile printing confirmation screen 120 displayed on the display unit 20. The sheet profile printing confirmation screen 120 is a confirmation screen to select whether to form the image including the sheet profile as the information regarding the sheets before changing. Below, forming the image including the sheet profile may be described as printing the sheet profile. The sheet profile printing confirmation screen 120 includes “YES” button B21 and “NO” button B22.

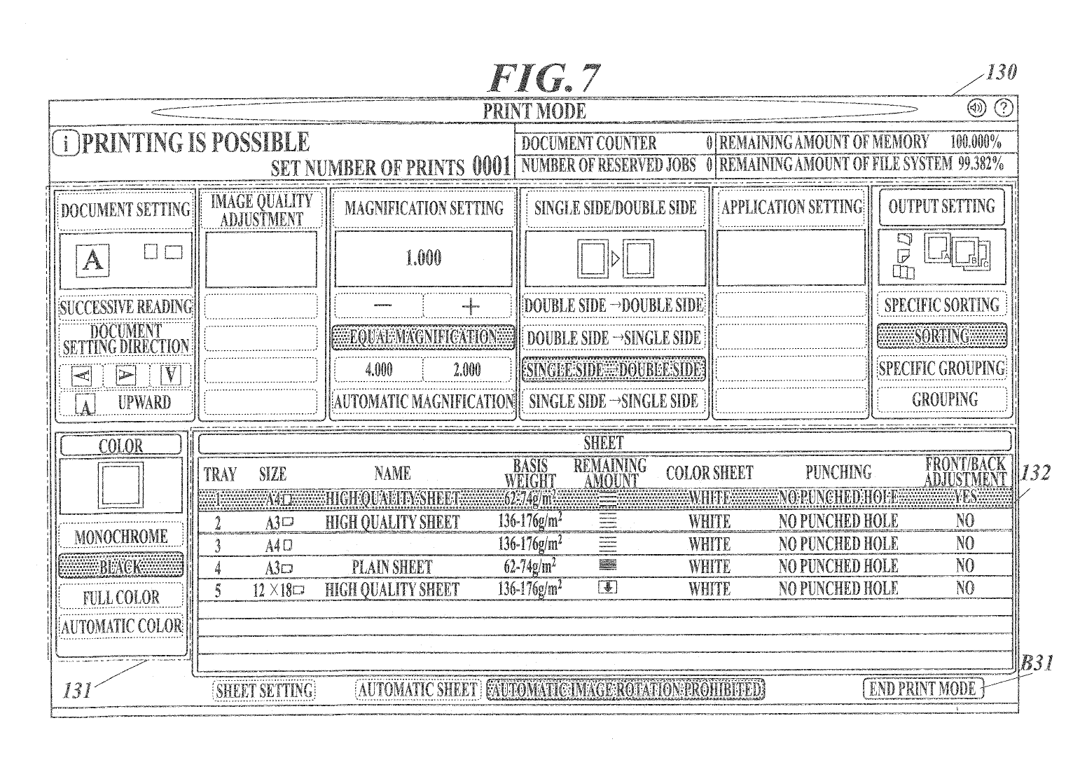

Next, the control unit 71 judges whether the user operated the operation unit 10 to select printing of the sheet profile of the sheet before changing on the sheet profile printing confirmation screen 120 (step S13). When the printing of the sheet profile of the sheet before changing is selected (step S13; YES), in other words, when the “YES” button B21 is pressed, the control unit 71 displays the print mode screen 130 (see FIG. 7) on the display unit 20 (step S14).

FIG. 7 shows an example of a print mode screen 130 displayed on the display unit 20. The print mode screen 130 includes a print setting region 131, a sheet selecting region 132, an end button B31, and the like. The print setting region 131 is a region to set the print condition. The sheet selecting region 132 is a region to select the sheet (here, the sheet on which the sheet profile is printed) as the printing target. The end button B31 is the button to instruct end of the print mode.

Next, the control unit 71 judges whether the user pressed the start button of the operation unit 10 (step S15). When the start button is pressed (step S15; YES), the control unit 71 reads out the sheet profile associated with the sheet feeding tray in which the sheets are changed (sheet feeding tray as the target of processing selected in step S3) from the storage unit 72, controls the image forming unit 40 and prints the sheet profile of the sheet before changing (step S16).

Here, the sheet on which the sheet profile is printed can be the sheet supplied from the sheet feeding tray which is the target of processing or can be the sheet supplied from the sheet feeding tray different from the sheet feeding tray which is the target of processing. Preferably, the sheet is the same size as the sheet which is taken out when the sheets are changed.

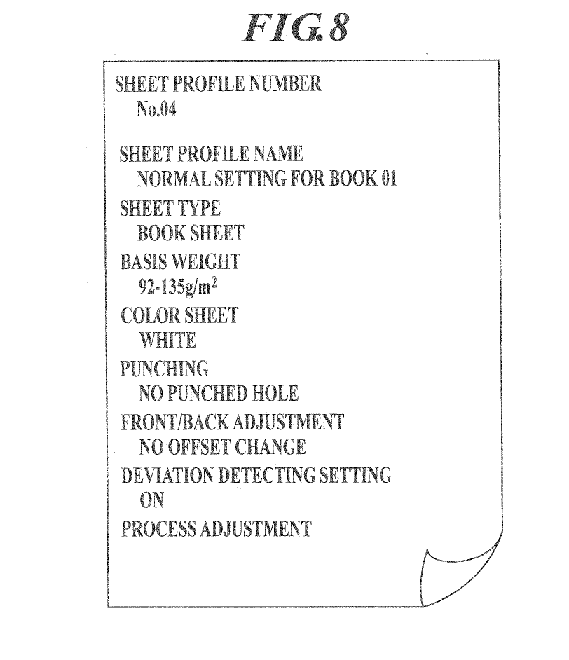

FIG. 8 shows an example of a sheet on which the sheet profile is printed. The following items are printed on the sheet, for example, sheet profile number, sheet profile name, sheet attribute (type, basis weight, color, etc.), presence of punched hole, process adjustment value, etc.

The content printed as information regarding the sheet before changing is not limited to the sheet profile or the sheet profile number corresponding to the sheet profile registered in advance, and only the attribute of the sheet specified by the user may be printed.

In step S15, when the start button is not pressed (step S15; NO), the control unit 71 judges whether the user operated the operation unit 10 to press the end button B31 of the print mode screen 130 (step S17). When the end button B31 is not pressed (step S17; NO), the processing returns to step S15, and the process is repeated.

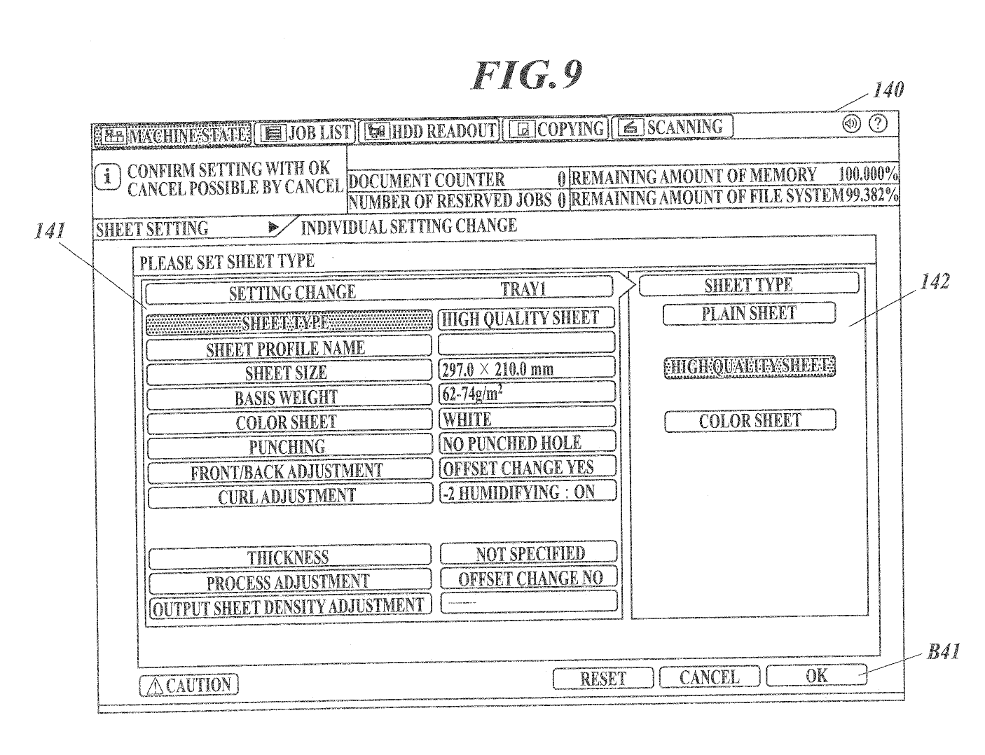

In step S13, when printing of the sheet profile of the sheet before changing is not selected (step S13; NO), in other words, when the “NO” button B22 of the sheet profile printing confirmation screen 120 is pressed, when the end button B31 of the print mode screen 130 is pressed in step S17 (step S17; YES), or after step S16, the control unit 71 displays the setting changing screen 140 (see FIG. 9) on the display unit 20 (step S18).

FIG. 9 shows an example of a setting changing screen 140 displayed on the display unit 20. The setting changing screen 140 includes a changing item selecting region 141, a detailed setting region 142, an OK button B41 and the like. The changing item selecting region 141 is a region to select the items to be changed (sheet type, sheet size, basis weight, etc.) in the information regarding the sheet of the selected sheet feeding tray. The detailed setting region 142 is a region to set the content to be changed on each item selected in the changing item selecting region 141. In FIG. 9, “sheet type” is selected in the changing item selecting region 141. Therefore, in the detailed setting region 142, “plain sheet”, “high quality sheet”, “color sheet” are displayed as the options to set the content of the “sheet type”. The OK button B41 is the button to confirm the content changed in the setting changing screen 140.

With this, the print profile printing process A ends.

Returning to FIG. 3, with the operation of the operation unit 10 by the user, the control unit 71 performs setting changing process for the sheet feeding tray which is the target of processing (step S6). Specifically, the user changes the information regarding the sheet in the sheet feeding tray which is the target of processing in the setting changing screen 140, and when the OK button B41 is pressed, based on the changed content, the control unit 71 updates the sheet profile corresponding to the sheet feeding tray which is the target of processing in the storage unit 72.

With this, the sheet setting changing process based on the user operation ends.

The sheet setting changing process based on the user operation is performed according to user operation when, for example, a job scheduling screen (a list screen showing the content of the job in the order to be performed) is displayed on the display unit 20 of the image forming apparatus 100 and the user confirms the content of the display and determines that the sheets need to be changed. Other examples in which the user determines that the sheets need to be changed include, when the sheet used in the next job is not included in any of the sheet feeding trays, when the sheet to be used in the job performed in the future is not included in any of the sheet feeding trays and there is a sheet feeding tray which is not used before the above future job, and the like.

The user takes out the bundle of sheets from the sheet feeding tray which is the target of processing and stores the bundle of sheets to be used newly in the sheet feeding tray. The user stores the sheet on which the sheet profile is printed placed on top of the bundle of sheets taken out from the sheet feeding tray. The changing of the sheets can be performed before the sheet setting changing process (see FIG. 3) based on the user operation starts.

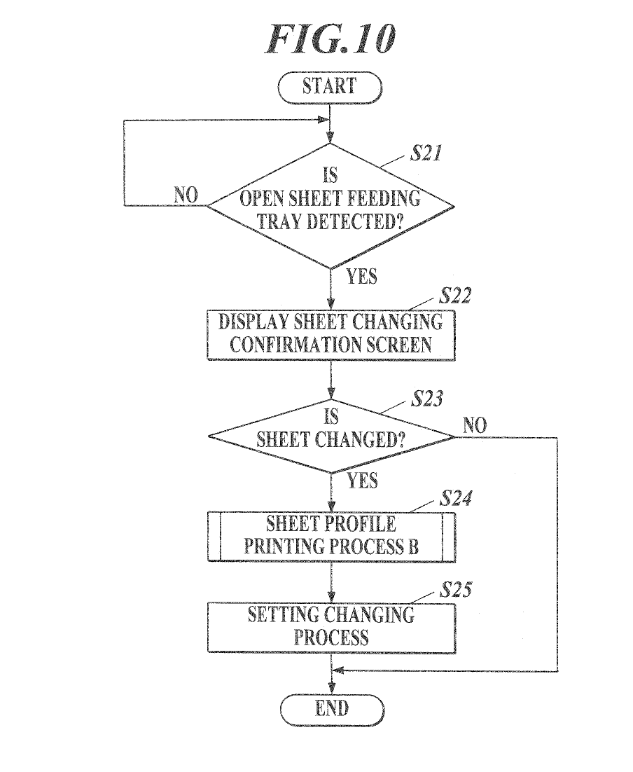

FIG. 10 is a flowchart showing a sheet setting changing process based on the sheet feeding tray open/close operation performed in the image forming apparatus 100. The process is realized by software processing performed by the CPU of the control unit 71 in coordination with the program stored in the ROM.

First, the control unit 71 judges whether it is detected that the user opened any one of the sheet feeding trays based on the output result of the open/close detecting sensor 75 provided in the sheet feeding trays T1 to T4 (step S21).

When it is detected that the sheet feeding tray is opened (step S21; YES), the control unit 71 displays a sheet changing confirmation screen on the display unit 20 (step S22). The sheet changing confirmation screen is a confirmation screen to select whether to change the sheets or to supply sheets in the opened sheet feeding tray.

When the user operates the operation unit 10 to select changing the sheets on the sheet changing confirmation screen (step S23; YES), the control unit 71 performs the sheet profile printing process B (step S24). Here, it is assumed that the sheet detecting sensor 76 detects that there are sheets in the opened sheet feeding tray.

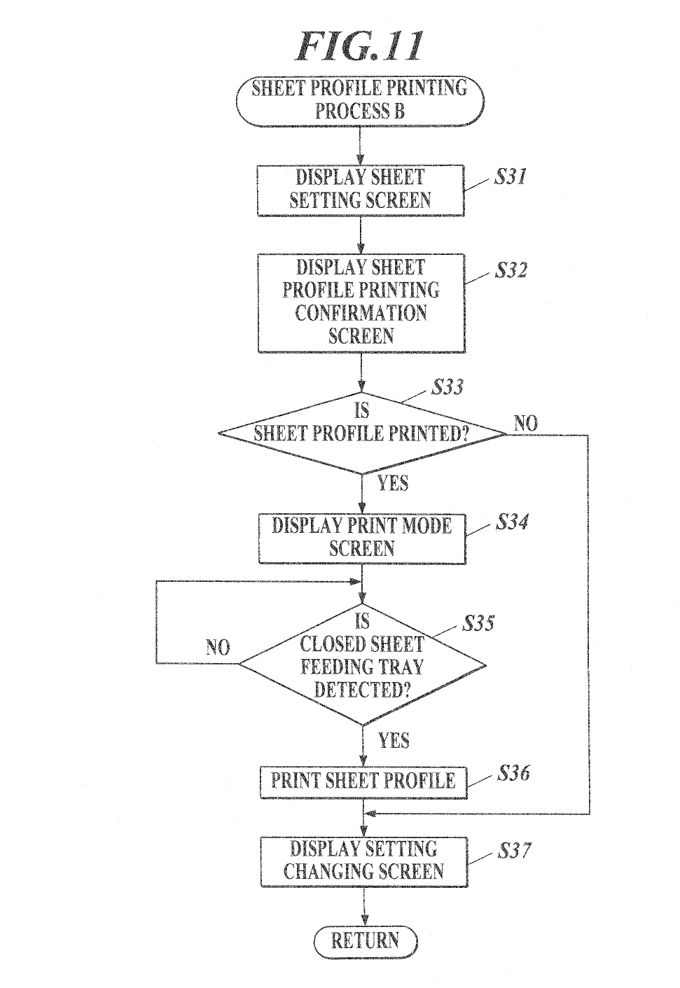

FIG. 11 shows the print profile printing process B.

The processing of steps S31 to S34 is the same as the processing of steps S11 to S14 of the sheet profile printing process A (see FIG. 5), and the description is omitted.

After step S34, the control unit 71 judges whether it is detected that the user closed the sheet feeding tray detected as being opened in step S21 based on the output result of the open/close detecting sensor 75 provided in each sheet feeding tray T1 to T4 (step S35).

When it is detected that the sheet feeding tray is closed (step S35; YES), the control unit 71 reads out the sheet profile corresponded to the closed sheet feeding tray from the storage unit 72 and controls the image forming unit 40 to print the sheet profile of the sheet before changing (step S36).

Here, the sheet on which the sheet profile is printed can be the sheet supplied from the sheet feeding tray in which the opening/closing is detected or can be the sheet supplied from the sheet feeding tray other than the above. Preferably, the size of the sheet is the same as the size of the sheet taken out by changing of the sheets.

From when it is detected that the sheet feeding tray is opened in step S21 (step S21; YES), to when it is detected that the sheet feeding tray is closed in step S35 (step S35; YES), the user takes out the bundle of sheets from the pulled out sheet feeding tray and stores the bundle of sheets to be used newly in the sheet feeding tray. The user stores the sheet on which the sheet profile is printed placed on the bundle of sheets taken out from the sheet feeding tray.

In step S33, when printing of the sheet profile of the sheet before changing is not selected (step S33; NO), or after step S36, the control unit 71 displays the setting changing screen 140 (see FIG. 9) on the display unit 20 (step S37).

With this, the sheet profile printing process B ends.

Returning to FIG. 10, with the operation of the operation unit 10 by the user, the control unit 71 performs the setting changing process of the sheet feeding tray in which the sheets are changed (step S25). The setting changing process is the same as step S6 of the sheet setting changing process (see FIG. 3) based on user operation.

After step S25 or when the changing of the sheet is not selected in the sheet changing confirmation screen (step S23; NO), in other words, when supplying of the sheet is selected, the sheet setting changing process based on the sheet feeding tray opening/closing operation ends.

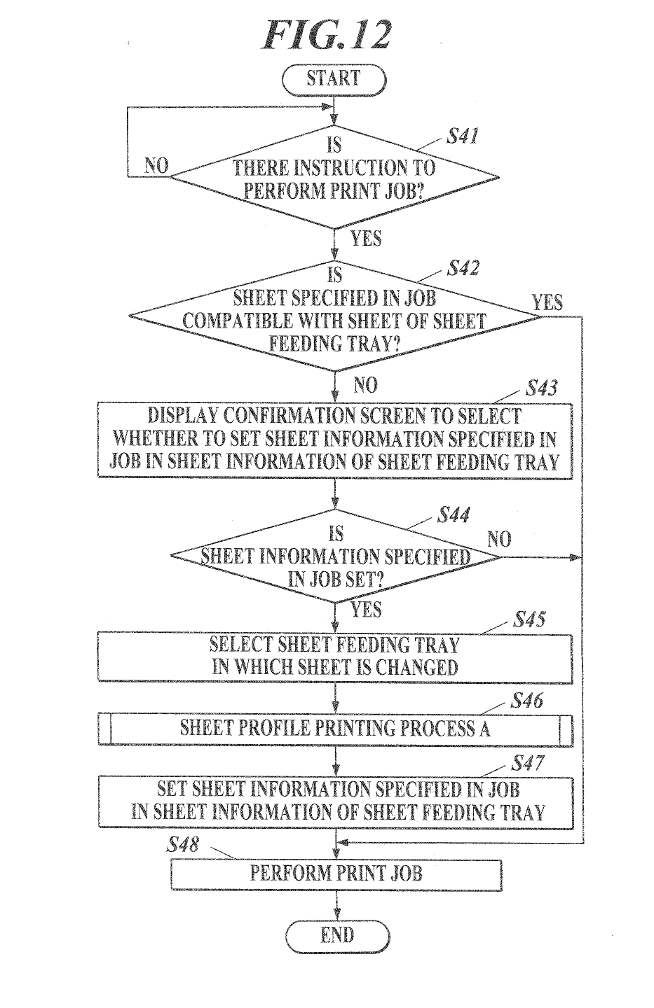

FIG. 12 is a flowchart showing a sheet setting changing process based on sheet incompatibility performed in the image forming apparatus 100. The process is realized by software processing performed by the CPU of the control unit 71 in coordination with the program stored in the ROM.

First, the control unit 71 judges whether there is an instruction to perform a print job (step S41). When there is the instruction to perform the print job (step S41; YES), the control unit 71 reads out the sheet profile associated with the sheet feeding trays T1 to T4 from the storage unit 72, and judges whether the sheet specified in the job is compatible with the sheets stored in any one of the sheet feeding trays T1 to T4 (step S42).

When the sheet specified in the job is not compatible with any of the sheets stored in the sheet feeding trays T1 to T4 (step S42; NO), the control unit 71 displays on the display unit 20 the confirmation screen to select whether to set the sheet information specified in the job (sheet attribute, sheet control information, etc.) in the sheet information of any one of the sheet feeding trays T1 to T4 (step S43).

Next, the control unit 71 judges whether the user operated the operation unit 10 to select to set the sheet information specified in the job in the sheet information of any one of the sheet feeding trays T1 to T4 (step S44). When it is selected to set the sheet information specified in the job in the sheet information of any one of the sheet feeding trays T1 to T4 (step S44; YES), and the user operates the operation unit 10 to select the sheet feeding tray in which the sheets are changed, the control unit 71 sets the selected sheet feeding tray as the target of processing (step S45).

Next, the control unit 71 performs sheet profile printing process A (see FIG. 5) (step S46).

Since the sheet profile printing process A is already described, the description is omitted here. The processing of step S18 in the sheet profile printing process A can be omitted.

The sheet on which the sheet profile is printed can be a sheet supplied from the sheet feeding tray which is the target of processing or can be the sheet supplied from the sheet feeding tray different from the sheet feeding tray which is the target of processing. Preferably, the sheet is the same size as the sheet taken out in changing the sheet.

Next, the control unit 71 sets the sheet information specified in the job as the sheet information of the sheet feeding tray in which the sheets are changed (step S47). Specifically, based on the sheet information specified in the job, the control unit 71 updates the sheet profile corresponding to the sheet feeding tray which is the target of processing in the storage unit 72.

The user takes out the bundle of sheets from the sheet feeding tray which is the target of processing and stores the bundle of sheets (sheet specified in the job) which is used newly in the sheet feeding tray. The user stores the sheet on which the sheet profile is printed placed on the bundle of sheets taken out from the sheet feeding tray.

Next, the control unit 71 controls the sheet feeding unit 50 to supply the sheet from the sheet feeding tray in which the sheets are changed, and controls the image forming unit 40 to perform the print job (step S48).

In step S42, when the sheet specified in the job is compatible with the sheet stored in any one of the sheet feeding trays T1 to T4 (step S42; YES), the control unit 71 controls the sheet feeding unit 50 to supply the sheet from the sheet feeding tray storing the sheet compatible with the sheet specified in the job, and controls the image forming unit 40 to perform the print job (step S48).

In step S44, when it is not selected to set the sheet information specified in the job in the sheet information of any one of the sheet feeding trays T1 to T4 (step S44; NO), the control unit 71 controls the sheet feeding tray 50 to supply the sheet from any one of the sheet feeding trays T1 to T4, and controls the image forming unit 40 to perform the print job (step S48). In this case, the sheet different from the sheet specified in the job is used.

With this, the sheet setting changing process based on sheet incompatibility ends.

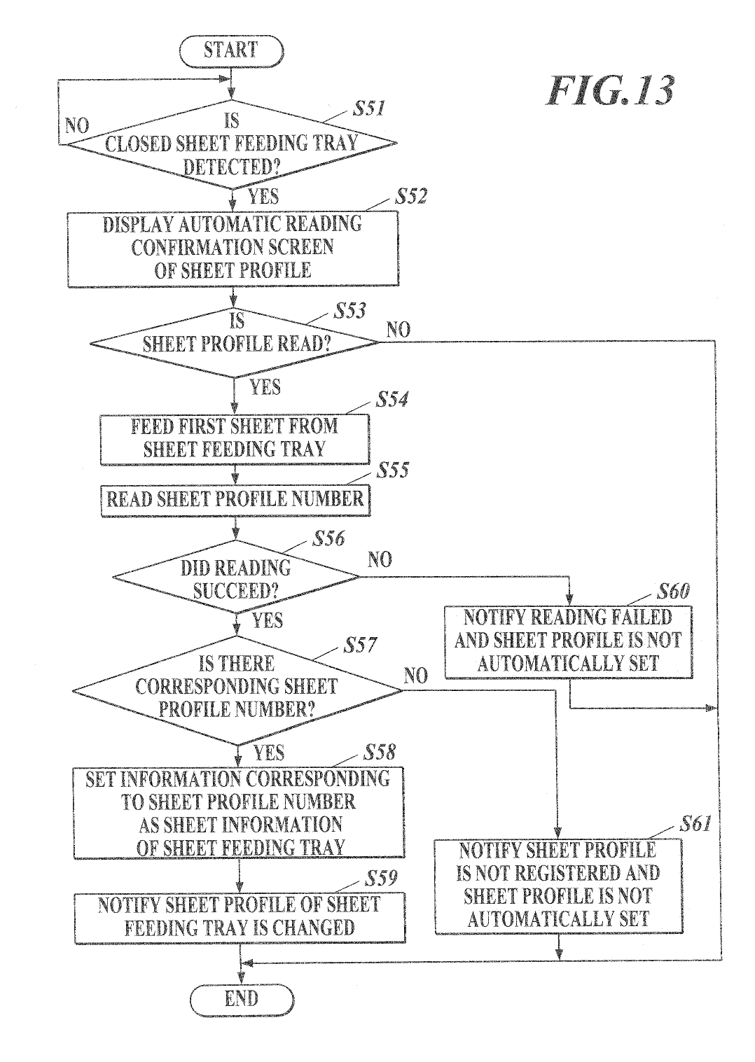

FIG. 13 is a flowchart showing the sheet profile setting process performed in the image forming apparatus 100. The process is realized by software processing performed by the CPU of the control unit 71 in coordination with the program stored in the ROM.

First, the user sets in any one of the sheet feeding trays T1 to T4 the stored bundle of sheets taken out from the sheet feeding trays T1 to T4 in a state so that the sheet on which the sheet profile is printed is fed first. Specifically, any one of the sheet feeding trays T1 to T4 is pulled out, the bundle of sheets is stored in a state with one of the sheet feeding trays T1 to T4 opened, and the pulled out sheet feeding tray T1 to T4 is closed and returned to the original state.

The control unit 71 judges whether it is detected that the user closed any one of the sheet feeding trays based on the output result of each open/close detecting sensor 75 provided in each sheet feeding tray T1 to T4 (step S51).

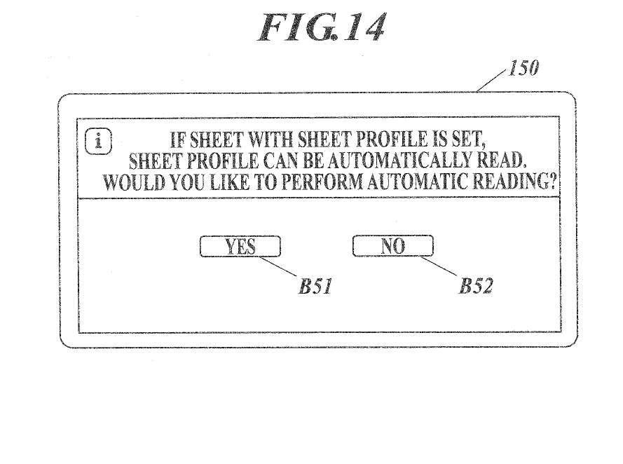

When it is detected that any one of the sheet feeding trays is closed (step S51; YES), the control unit 71 displays a sheet profile automatic reading confirmation screen 150 (see FIG. 14) on the display unit 20 (step S52),

FIG. 14 shows an example of the sheet profile automatic reading confirmation screen 150 displayed on the display unit 20. The sheet profile automatic reading confirmation screen 150 is a confirmation screen to select whether the sheet profile is read from the top sheet of the bundle of sheets set in the sheet feeding tray. The sheet profile automatic reading confirmation screen 150 includes “YES” button B51 and “NO” button B52.

When reading the sheet profile is selected (step S53; YES), in other words, when the “YES” button B51 is pressed on the sheet profile automatic reading confirmation screen 150, the control unit 71 controls the sheet feeding unit 50 and feeds the first sheet of the bundle of sheets set in the sheet feeding tray detected to be closed in step S51 (step S54), and controls the image reading unit 70 to read the sheet profile number printed on the sheet (step S55). The control unit 71 analyzes the image data obtained by reading the sheet on which the sheet profile number is printed and recognizes the character to make an attempt to obtain the sheet profile number. The method to obtain the sheet profile number is not limited to character recognition and can be obtained by reading a barcode, a two-dimensional code, etc. printed on the sheet.

Next, the control unit 71 judges whether the image reading unit 70 succeeded in reading the sheet profile number (step S56). When the reading of the sheet profile number succeeds (step S56; YES), the control unit 71 judges whether the sheet profile number applying to the read sheet profile number is stored in advance in the storage unit 72 (step S57).

When the sheet profile number applying to the read sheet profile number is stored in advance in the storage unit 72 (step S57; YES), the control unit 71 sets the information of the sheet profile corresponding to the sheet profile number as the sheet information of the sheet feeding tray detected to be closed in step S51 (step S58). Specifically, the control unit 71 reads the sheet profile corresponding to the read sheet profile number from the storage unit 72, and based on the sheet profile, the sheet profile corresponding to the sheet feeding tray (the sheet feeding tray detected to be closed in step S51) stored in the storage unit 72 is updated.

Next, the control unit 71 notifies by displaying on the display unit 20 that the sheet profile of the sheet feeding tray in which the sheets are changed is changed (step S59).

In step S56, when the reading of the sheet profile number does not succeed (step S56; NO), the control unit 71 notifies by displaying on the display unit 20 that the reading of the sheet profile number failed and the automatic setting of the sheet profile is not performed (step S60).

In step S57, when the sheet profile number applying to the read sheet profile number is not stored in advance in the storage unit 72 (step S57; NO), the control unit 71 notifies by displaying on the display unit 20 that the automatic setting of the sheet profile is not performed because the sheet profile is not registered (step S61).

After step S59, after step S60, after step S61, or when the reading of the sheet profile is not selected in step S53 (step S53; NO), in other words, when the “NO” button 352 of the sheet profile automatic reading confirmation screen 150 is pressed, the sheet profile setting process ends.

As described above, according to the image forming apparatus 100 of the present embodiment, the image including the information regarding the sheet before changing is formed when the sheets of the sheet feeding trays T1 to T4 are changed. Therefore, the information regarding the sheets before changing can be managed on the sheet. The user is able to store the sheet on which the image including the information regarding the sheet before changing is formed placed on the bundle of sheets taken out from the sheet feeding trays T1 to T4. Therefore, it is possible to know the information regarding the sheets before changing (bundle of sheets) by looking at the sheet placed on the bundle of sheets, and it is possible to easily manage the information regarding the sheets taken out when the sheets in the sheet feeding trays T1 to T4 are changed.

For example, when the information regarding the sheet stored in the sheet feeding trays T1 to T4 is changed, the image including the information regarding the sheet before changing can be formed.

When the sheet feeding trays T1 to T4 are opened and closed with the changing of the sheets, the image including the information regarding the sheets before changing can be formed.

When the sheet specified in the job is different from the sheets stored in the sheet feeding trays T1 to T4, the image including the information regarding the sheets before changing can be formed.

The user is able to select whether to form the image including the information regarding the sheets before changing, therefore, if there is no need to form the image including the information regarding the sheets before changing, this process can be omitted.

When the bundle of sheets which is taken out is used next, the image reading unit 70 reads the information regarding the sheets before changing from the sheet on which the image including the information regarding the sheets before changing is formed, and the sheet profile corresponding to the information regarding the sheets before changing is set as the information of the sheets newly stored in the sheet feeding trays T1 to T4. Therefore, the information regarding the sheets taken out in changing can be easily set. Moreover, it is possible to prevent human error in the setting and to reduce the number of steps in the operation.

When the information regarding the sheets before changing cannot be read, or there is no sheet profile corresponding to the read information regarding the sheets before changing, it is notified that the sheet profile is not automatically set. Therefore, this can call attention of the user.

The description of the present embodiment is one example of the image forming apparatus regarding the present invention, and the present invention is not limited to the above. The detailed configuration and operation of each unit composing the apparatus can be suitably changed without leaving the scope of the present invention.

For example, according to the present invention, the image reading unit 70 reads the information regarding the sheets before changing. Alternatively, the sheet on which the image including the information regarding the sheets before changing is formed can be set in the scanner 30, and the scanner 30 can read the information regarding the sheets before changing.

According to the present embodiment, the image forming apparatus 100 is provided with the sheet feeding unit 50 and the sheet processing unit 60. Alternatively, the sheet feeding unit 50 and the sheet processing unit 60 can be individual devices and these can be connected with the image forming apparatus to form an image forming system.

According to the description above, a ROM is used as the computer readable medium storing the program to perform the above processing, however, it is not limited to the above. A non-volatile memory such as a flash memory, portable storage medium such as a CD-ROM or the like can be applied as the computer readable medium. A carrier wave can be applied as the medium to provide data of the program through communication lines.

The present invention is not limited to the embodiments and configurations as described above, and the embodiments can be suitably modified without leaving the scope of the invention.

The present U.S. patent application claims priority under the Paris Convention of Japanese Patent Application No. 2014-246392 filed on Dec. 5, 2014 the entirety of which is incorporated herein by reference.

What is claimed is:

1. An image forming apparatus comprising:
a sheet feeding tray which stores and feeds a sheet;
an image forming unit which forms an image on a sheet fed from the sheet feeding tray; and
a control unit which controls the image forming unit to form an image including information regarding a sheet before changing when operation including changing of a sheet stored in the sheet feeding tray is performed or there is a necessity to change a sheet stored in the sheet feeding tray.

2. The image forming apparatus of claim 1, wherein, the operation including changing of the sheet includes changing information regarding the sheet stored in the sheet feeding tray or opening or closing of the sheet feeding tray.

3. The image forming apparatus of claim 2, wherein, the control unit displays on a display unit a confirmation screen to select whether to change the sheet or to supply the sheet when the sheet feeding tray is opened, and when the change of the sheet is selected, the control unit controls the image forming unit to form the image including the information regarding the sheet before changing when the sheet feeding tray is closed.

4. The image forming apparatus of claim 1, wherein, the control unit determines that the sheet needs to be changed when a sheet specified in a job is different from a sheet stored in the sheet feeding tray.

5. The image forming apparatus of claim 1, wherein, the control unit displays on a display unit a confirmation screen to select whether to form an image including information regarding the sheet before changing, and when forming the image including the information regarding the sheet before changing is selected, the control unit controls the image forming unit to form an image including the information regarding the sheet before changing.

6. The image forming apparatus of claim 1, wherein, the information regarding the sheet before changing includes at least one of the following, information showing a sheet profile of the sheet before changing, an attribute of the sheet before changing or control information of the sheet before changing.

7. The image forming apparatus of claim 1,
further comprising, an image reading unit which reads information regarding the sheet before changing from a sheet on which an image including information regarding the sheet before changing is formed,
wherein, the control unit sets a sheet profile corresponding to information regarding the sheet before changing based on the information regarding the sheet before changing read by the image reading unit as information of a sheet newly stored in the sheet feeding tray.

8. The image forming apparatus of claim 7, wherein,
the sheet on which the image including the information regarding the sheet before changing is formed is stored as the first sheet to be fed with the sheet before changing in the sheet feeding tray; and
the image reading unit reads the information regarding the sheet before changing from the first sheet fed from the sheet feeding tray.

9. The image forming apparatus of claim 7, wherein, the control unit notifies that the sheet profile is not automatically set when the image reading unit cannot read information regarding the sheet before changing or there is no sheet profile corresponding to the information regarding the sheet before changing read by the image reading unit.

10. An image forming system comprising:
a sheet feeding unit including a sheet feeding tray which stores and feeds a sheet;
a sheet processing unit which performs predetermined sheet processing on the sheet;
an image forming unit which forms an image on a sheet fed from the sheet feeding tray; and
a control unit which controls the image forming unit to form an image including information regarding a sheet before changing when operation including changing of a sheet stored in the sheet feeding tray is performed or there is a necessity to change a sheet stored in the sheet feeding tray.

11. An image forming method in an image forming apparatus including a sheet feeding tray which stores and feeds a sheet; an image forming unit which forms an image on a sheet fed from the sheet feeding tray; and a control unit, the method comprising:
forming by the control unit controlling the image forming unit to form an image including information regarding a sheet before changing when operation including changing of a sheet stored in the sheet feeding tray is performed or there is a necessity to change a sheet stored in the sheet feeding tray.

12. The image forming method of claim 11, wherein, the operation including changing of the sheet includes changing information regarding the sheet stored in the sheet feeding tray or opening or closing of the sheet feeding tray.

13. The image forming method of claim 12, further comprising,
displaying by the control unit controlling a display unit to display a confirmation screen to select whether to change the sheet or to supply the sheet when the sheet feeding tray is opened; and
when the change of the sheet is selected, forming by the control unit controlling the image forming unit to form the image including the information regarding the sheet before changing when the sheet feeding tray is closed.

14. The image forming method of claim 11, further comprising, determining by the control unit that the sheet needs to be changed when a sheet specified in a job is different from a sheet stored in the sheet feeding tray.

15. The image forming method of claim 11, further comprising,
displaying by the control unit controlling a display unit to display a confirmation screen to select whether to form an image including information regarding the sheet before changing; and
when forming the image including the information regarding the sheet before changing is selected, forming by the control unit controlling the image forming unit to form an image including the information regarding the sheet before changing.

16. The image forming method of claim 11, wherein, the information regarding the sheet before changing includes at least one of the following, information showing a sheet profile of the sheet before changing, an attribute of the sheet before changing or control information of the sheet before changing.

17. The image forming method of claim 11,
wherein, the image forming apparatus further includes an image reading unit,
the method further comprising,
reading by the image reading unit information regarding the sheet before changing from a sheet on which an image including information regarding the sheet before changing is formed; and
setting by the control unit a sheet profile corresponding to information regarding the sheet before changing based on the information regarding the sheet before changing read by the image reading unit as information of a sheet newly stored in the sheet feeding tray.

18. The image forming method of claim 17, wherein,
the sheet on which the image including the information regarding the sheet before changing is formed is stored as the first sheet to be fed with the sheet before changing in the sheet feeding tray; and
in the reading, the image reading unit reads the information regarding the sheet before changing from the first sheet fed from the sheet feeding tray.

19. The image forming method of claim 17, further comprising,
notifying by the control unit that the sheet profile is not automatically set when the image reading unit cannot read information regarding the sheet before changing or there is no sheet profile corresponding to the information regarding the sheet before changing read by the image reading unit.
